(19) United States
(12) Patent Application Publication
(10) Pub. No.: US 2011/0068126 A1
(43) Pub. Date: Mar. 24, 2011

(54) System for providing portioned and tempered beverages for mobile use

(76) Inventor: Hubert Eric Walter, Ulm (DE)

(21) Appl. No.: 12/736,294

(22) PCT Filed: Mar. 26, 2009
(86) PCT No.: PCT/DE2009/000440

§ 371 Date: Dec. 2, 2010

(30) Foreign Application Priority Data
Mar. 27, 2008 (DE) 10 2008 016 671.5

(51) Int. Cl. B67D 7/80; B67D 7/06

(52) U.S. Cl. 222/146.1; 222/183

(57) ABSTRACT

The invention relates to a system for providing portioned and temperature-controlled beverages in mobile use. It is the object of the invention to produce possibilities with which the most varied of temperature-controlled beverages can be made available for consumption and the technical equipment outlay and also the energy consumption can thereby be reduced. In the case of a system according to the invention, a heat-insulated receptacle for receiving at least one container containing temperature-controlled water and at least one dispensing element containing a liquid or powder concentrate are present.

The invention relates to a system for providing portioned and temperature-controlled beverages in mobile use, the use being particularly advantageous in aircraft. However, at least individual elements of the system are also suitable for transport and safe storage of other foodstuffs or pharmaceutical products.

For serving different beverages which are intended to be made available as hot beverages or cooled beverages, beverages contained in the most varied of vessels or receptacles have in fact to date been stored, transported and then served as finished product in cooled form. In the case of the desired different beverages, this demands high logistical complexity. In addition, generally far too large a number of vessels or receptacles is transported without them being required. Approx. 70% of the beverages carried in aircraft during a flight are thus not consumed.

The result of this is a transport mass which is actually not required and in turn increases the energy- or fuel consumption.

For hot beverages, it is normal to heat water to the required temperature in situ, i.e. also in a vehicle, and then to prepare the respective drink with the hot water. For this purpose, a high energy requirement is likewise needed but which in mobile use is inconvenient and has a negative effect on the fuel consumption of a vehicle.

In mobile use, increased costs therefore occur and a reduction in useful mass is taken into account, which in turn results in increased costs.

However, frequently also cooling or heat-maintaining devices are used in mobile use, with the help of which the respective temperature of beverages or also other foodstuffs is intended to be maintained over a fairly long period of time. Here also, the necessary energy requirement and the intrinsic mass of such devices have a negative effect.

It is therefore the object of the invention to produce possibilities with which the most varied of temperature-controlled beverages are made available for consumption and the technical equipment outlay and also the energy consumption can thereby be reduced.

According to the invention, this object is achieved with a system which has the features of claim 1.

Advantageous embodiments and developments of the invention can be achieved with features described in subordinate claims.

The system according to the invention is formed with a plurality of elements which can be combined variably with each other and supplemented by further elements. At least one heat-insulating receptacle is present. Then at least one container which contains temperature-controlled water can be inserted into the receptacle. In addition, at least one vessel for the actual serving of the respective temperature-controlled drink can be present. The vessel can thereby be a glass or a cup for a beverages portion but also a pot for a plurality of portions. In order to make different beverages available, at least one dispensing element is present. In the dispensing element, a liquid or powder concentrate for the respective drink is contained, the concentrate content being intended to be measured such that it corresponds to a beverages portion of the respective vessel to be served, i.e. can be measured for a glass or a cup but also for the contents of a pot. Thus, for example different juices, tea or coffee beverages can be prepared with a concentrate and the correspondingly temperature-controlled water for consumption in situ. If desired, the possibility however exists of being able also to prepare hot soup with a corresponding concentrate.

A water-containing container can be heated or cooled centrally, e.g. at a caterer's, and then inserted in a heat-insulated receptacle. In the closed receptacle, the temperature of the water can then be maintained by the insulation over a sufficiently long period of time, slight heating or cooling being tolerable. Thus the temperature-controlled water can be transported and for example can be transported in and also to a vehicle (e.g. aircraft). As needed, a required quantity of water can then be removed from the container and placed in a vessel together with the concentrate from the dispening element, possibly stirring being able to be effected. For the stirring, a dispensing element suitably configured for this purpose, for example a bar- or spoon-shaped element, can be used. The respective concentrate can thereby be contained in a sealable cavity.

Also during transport from a caterer to the location of the actual consumption (e.g. a vehicle), in addition suitable insulation should be used for heated material or a cooled vehicle or cooling container.

In a development of the invention, also the heat-insulated receptacle or a further identically or similarly configured heat-insulated receptacle can however also be used in order to keep a vessel with the respective already prepared drink further at temperature. Thus one or a plurality of pots can be inserted in such a receptacle. In the closed receptacle, the temperature of the drink can be maintained constant or with only slight heating or cooling over a fairly long period of time. This period of time can also be increased by the vessel likewise having a heat-insulating configuration.

Receptacles can be designed in normal standard dimensions so that they can be integrated or inserted in devices which are present, such as is the case for example in onboard kitchens (galleys).

A receptacle should have a heat-conduction coefficient of less than 0.05 W/mK, preferably less than 0.005 W/mK.

In order to improve the thermostatic effect, receptacles, possibly however also containers for water or also vessels, should be formed with at least one vacuum insulation panel element. These are formed with a carrier and/or a porous material which is sealed externally to be gas-impermeable, the cavities having been evacuated before being sealed. Suitable foils, preferably also multilayer, can be used for sealing. The gas-impermeable seal can however also be achieved alone or additionally with a rigid sealed outer cover or shell made of metal or of a suitable plastic material. More concrete possibilities for a suitable construction are intended to be dealt with subsequently in more detail.

In a heat-insulating receptacle, a further container or a contoured insert element can be inserted. A heat-insulating receptacle can also be contained in a container which can fulfil a protective function against a mechanical external effect. Such containers can be formed from a suitable plastic material, in or on the walls of which insulation layers can be present. However, also such a coating is possible on the outside of a receptacle.

On a heat-insulating receptacle and/or a container, also a pressure equalisation opening can be present via which for example outgassing dry ice can escape or with which condensate formation can be avoided. Also a suitable membrane or a valve can be present there.

It is particularly advantageous to design or to dimension the interior of heat-insulated receptacles geometrically such that the inner volume can be used optimally. This can be achieved with correspondingly designed and dimensioned containers for water or also vessels. Square geometries are particularly suitable for this purpose. Thus cuboid interiors of receptacles in combination with receptacles for water or vessels with a cornered (rectangular, square) cross-section can be used and dead spaces are thereby extensively avoided in a receptacle.

Containers for water can however also be used in bag form made of a plastic material film, which are well adapted to the interior geometry of a receptacle because of the flexibility and these can be completely filled out.

However the possibility also exists of providing such containers for water with an outer cover which has increased mechanical strength, and a liquid-impermeable inner foil. The outer cover can consist of a compostable material, such as e.g. a cardboard box, and a cuboid shape of a container can be chosen.

Flexible containers for water or other liquids can however also be kept temperature-controlled in an insert element. At least one such container can thereby be inserted in an insert element. An insert element can thereby be an open tub.

It is advantageous to configure the base of a heat-insulating receptacle, insert element or a container inclined at an oblique angle. With an angle of inclination in the range of 5° to 10°, gravitational force-related emergence of the liquid or water can be achieved without further aids. Such an inclination of the base can however also preferably be present with an insert element. Then, a cavity which is kept free below the insert element in a heat-insulating receptacle or container can be used for accommodating further elements, such as e.g. latent heat storage elements, electrical energy storage elements, heating or cooling elements inter alia. Insert elements can also be exchanged easily and simply.

With the invention, also heat tubes or two-phase thermosiphons can be used for temperature control. The internal pressure and the contained fluid can thereby be coordinated to the respectively desired temperature. Thus a temperature can be maintained better and longer. Cooling or fairly long heat retention can thereby be achieved.

Also in the case of latent heat storage elements, adaptation to desired temperatures can be taken into account, if a medium in which a phase transition is effected in the range of the desired temperature is used for them. Thus, a medium, in which a phase transition occurs at a few degrees Kelvin above the desired temperature, can be used for keeping warm.

Within heat-insulating receptacles, a homogeneous temperature can also be maintained. For this purpose, suitable elements with which specific influencing of the airflow in the interior can be achieved can be present. For example flow masks or channels can be used. With fans, recirculation but also advantageously the flow from heating, cooling or storage elements can however be directed specifically into other interior regions so that heat or cold can also move into further removed interior regions. Control or regulation of fans can thereby be undertaken and effected preferably as a function of the temperature. Also a plurality of fans can be present on one unit, which fans achieve their maximum power in different directions so that different flow ratios can be adjusted and increased variability can be achieved during temperature equalisation in the interior. A plurality of fans can be disposed adjacently but also in succession.

In order to determine the average temperature in the interior, the fans can be operated such that a flow is initiated for a short time in one direction and subsequently in another or the opposite direction. The temperature change can thereby be detected and taken into account.

Fans can conveniently be exchangeable. They can thereby be placed for use on corresponding plug-in contacts and be withdrawn simply for any cleaning required. In the case of a water-impermeable configuration of fans these can be cleaned simply, rapidly and economically and thereafter be reinserted without difficulty.

The containers can also have at least one outflow element for the portioned output of temperature-controlled water or other liquids into vessels which can be configured for example with a sealable valve. Containers can be configured with a plurality of chambers which are separated from each other so that a plurality of liquids or different beverages can correspondingly be contained. An outflow element can then be present at the individual chambers. For particular preference, exchangeable outflow elements should be used which can also be used as disposable articles. They can then be secured to suitable connection pipes of the containers, insert elements or a heat-insulating receptacle for use, for example by means of simply plugging in or on. Outflow elements can be configured as one- or multiway valves. A pressure equalisation for example is possible with multiway valves when drawing off liquid.

The outflow can thereby be disposed on the container such that water only flows out due to a gravitational force and a further valve or a water-impermeable membrane can be present for this purpose in order thus to enable the inflow of ambient air and the avoidance of low pressure in the container. However, the water can also be removed from the container by the assistance of a gas at increased pressure. For this purpose, a gas pressure container can be connected to the container. Also a combination with a suitable compressor can be used here in order to make available an increased gas pressure. This can for example be a pump which can also possibly be actuated manually.

In order to reduce further the undesired heating or cooling of water or a drink in a heat-insulated receptacle, the possibility exists of inserting suitable latent energy stores into the receptacle. In the interior of a heat-insulated receptacle, recesses or receiving means with an adapted contour for such latent energy storage elements can thereby be present. However, the possibility also exists, alone or additionally, of configuring such contours on containers for water, insert elements or vessels such that cavities are present into which such latent energy storage elements or other elements (heat tubes) suitable for temperature control can be introduced. Thus an intimate contacting contact can be achieved and in addition a form-fitting support can be achieved, avoiding slippage of containers or vessels within a receptacle. Latent energy storage elements can be adapted by their external shape in a complementary manner to contours of a receptacle and/or to outer contour elements of containers or vessels which are intended to be included in receptacles and kept insulated. They can for example have a concave contour into which a convex contour of a container or vessel can be introduced almost exactly.

It can also be advantageous to design and dimension latent energy stores geometrically such that they can be inserted in various receptacles in combination with different insert elements, containers or vessels and thereby are however designed respectively in the same shape as a standard element.

In addition to the already mentioned latent energy stores, also use of cooling or heating elements can however be provided on a receptacle. However, since it is desired to operate the invention in a self-sufficient manner, i.e. without connection to an energy supply, for example an onboard power system of a vehicle, the energy supply should be effected locally there. Correspondingly, fuel cells or photovoltaic units are possible. Peltier elements can be used for cooling or heating with the consequently obtained electric energy. For an electric energy supply, also an externally accessible connection, for example a low voltage connection, can however be present. However, also other types of voltage can be used. This connection can be designed such that it can be used as interface for data transfer, e.g. stored temperature data.

A supply of electric energy can however also be effected in a contact-free manner by inductive or capacitative transmission. Then, corresponding antennae or capacitors can be present for example in the housing of heat-insulating receptacles.

In the invention, it is also convenient to provide the individual elements with identification elements which can be useful for the logistics, use and data detection. There can be used for this purpose barcodes which are known per se but also RFID-based identification elements which can be operated without wires and contacts. Identification elements can be fitted on receptacles, containers, vessels and dispensing elements.

Dispensing elements, as mentioned already, can have a bar- or spoon-shaped configuration. However, also tubular bags, preferably narrow extended ones, can be used. Since, in addition to powder concentrates, preferably liquid ones can be used, a sleeve which covers an outflow opening at least partially should be present on an end-side, which sleeve can avoid soiling of the fingers during opening and emptying.

Dispensing elements can however also be present together with a vessel. A dispensing element can thereby be disposed within a vessel (cup or pot). Before filling with temperature-controlled water, a sealing element can be opened or removed so that a mixture of concentrate and water is contained in the vessel after filling with water. A dispensing element can also be disposed on the base of a vessel or also form the base of the vessel.

In the case of dispensing elements, the possibility also exists of producing this completely or also in regions from a material, substance or substance mixture which is water-soluble so that the concentrate can be released upon contact with water. Also materials or substances which are water-soluble or more water-soluble only from a prescribable temperature can be used preferably here. These can be for example cellulose- or sugar-based substances.

Heat-insulated receptacles can be provided with sealable openings in order to fill these or also to be able to remove again containers, vessels, other foodstuffs, objects or pharmaceuticals contained therein. These can be simple slides or cover elements. A seal can however also be achieved, in particular in the case of stationary use, e.g. in an onboard kitchen, with a door element. A secure seal should be present thereon, which can avoid unintentional opening or leaving open thereof. A seal can be configured as a double seal, both sealing elements acting independently of each other and one alone sufficing to ensure a impermeable seal of the container. In addition, further elements, for example magnetically acting elements, can be present. Seals, preferable labyrinth seals, can be configured on doors or cover elements.

However, also a sealable opening can be configured there, via which refilling with water or liquid can be effected.

In particular in the case of receptacles for stationary use, it can be convenient to provide an outflow element for water out of a container directly, to which a container with water can be connected. Temperature-controlled water can also be filled from the container contained in a protected manner in the receptacle via the outflow element into a vessel for providing the respective drink prepared with the concentrate without the container containing water requiring to be removed from the heat-insulated receptacle. The outflow element can thereby be formed from a material (e.g. ceramic, plastic material) with low heat conductivity.

Heat-insulated receptacles can be configured for transport also with at least one handle element. The possibility also exists that guide rails are fitted, with which insertion into an onboard kitchen system present is possible. As a result, compatibility with systems and elements already present (drawers, ovens, trolleys, units, spice boxes) can be achieved taking into account the dimensions of these and thereby holding points, -elements or fixing elements already present.

Insert elements can also be inserted into heat-insulated receptacles. On such insert elements, contour elements in the form of recesses or receiving means can be configured, into which in turn correspondingly adapted contoured objects, packaging, containers, vessels or others are inserted and retained therein securely positioned also during transport. Insert elements should be produced from materials or substances which have low heat conductivity and, as far as possible, also low physical density. They should have sufficient strength and possibly be usable several times. This can be achieved for example with cardboard boxes or plastic materials, such as e.g. plastic material foamed parts. The last-mentioned can also be cleaned.

On or also in heat-insulated receptacles, also elements optically displaying the internal temperature should be present. These can be temperature strips which can be used again and with which temperatures are displayed for example by different colour tones or also analogous trailing pointer thermometers.

A temperature determination or also temperature monitoring can however be achieved also with suitable sensor elements and possibly an electronic storage medium. Electric energy from a suitable element can then be used here in situ (fuel cell, photovoltaics) or from an energy storage element. The respective temperature can thereby be displayed also on a display. With suitable data stores, also demonstration can be provided relating to the maintenance of specific temperatures until usage. The reading-in or reading-out of data can also be effected without wires. However, this is also possible with a suitable externally accessible standardised interface.

This is also possible in conjunction with wire-free RFID technology, possibilities of a wire-free energy transmission also being able to be used in combination with a thereby present electric energy store.

Elements displaying the internal temperature should have a water-impermeable design in order to maintain the required hygiene specifications and to enable cleaning.

It can also be advantageous if it is readily visible from outside whether cooled or heated water or correspondingly other articles, foodstuffs or other objects is/are contained in the interior of heat-insulated receptacles. This can be achieved with an indicator element fitted thereon. Such an indicator element can indicate this for example by showing a colour, e.g. blue or red. A corresponding indicator element can thereby be inserted simply into a receiving means or display the respective state by a pivot movement. However, the state can also be indicated by readable letters.

In order to enable optimum usage of space and also good handling, vessels for serving temperature-controlled beverages in which preferably a plurality of drink portions is contained can have an outflow element (outflow spout) and/or a handle element on which a hand can engage. The design and dimensioning with a corresponding arrangement on a vessel can thereby be chosen such that complementary contours are present. A protruding outflow spout can thereby be contoured such that it can be introduced into a corresponding contour which is configured for example in the region of a handle element of another vessel if both vessels stand adjacently. This also leads to the fact that a movement of the adjacently standing vessels can be avoided even in the case of externally acting accelerations. In the case of improved functionality of the vessels, a secure support and optimum use of space can thus be achieved, this also being possible if a plurality of such vessels is contained in one heat-insulated container.

The already mentioned vacuum insulation panel elements can be produced with porous materials or substances, these being able to be for example microporous aerogel materials (silicic acid). In addition, a honeycomb structure made of a material of low heat conductivity can be present as carrier structure in such a panel element. The hollow honeycombs (octahedron or other geometries) can be filled with the microporous material. As material, a Nomex paper covered with synthetic resin but also a suitable plastic material can however be used. The entire item can then be enclosed in a cover foil which can be glued also to the honeycomb structure. In the cover foil, a perforation can be configured for evacuation. The breakthroughs of the perforation can be sealed again in a gas-impermeable manner after evacuation, which can be achieved by an additional foil but also by a carrier which can be connected to the foil. The carrier can be a plate or also a differently configured carrier element which is adapted to the desired shape, as can be the case for example with thus insulated vessels. Carriers (comprising e.g. metal or plastic material) can form a seal on all sides and the gas-impermeability can be achieved by welding.

Strength and insulation effect can be further increased if two honeycomb structure elements are disposed one above the other. The honeycombs are thereby orientated in fact in the same direction but disposed offset relative to each other so that the respectively contacting surface is reduced.

In the case of a very small wall thickness, a high heat insulation effect can be achieved with vacuum insulation panel elements. With a wall thickness of 7 to at most 12 mm and with a heat-conduction coefficient of approx. 0.005 W/mK, the same effect as with other heat insulation materials, which are known per se, with at least double thickness can be achieved, which has an advantageous effect in mobile use.

Heat bridges should be avoided or preferably no heat bridges should be present. As mentioned previously, a reduction is possible by the offset arrangement of the honeycomb structures. No heat bridges are produced for example if a homogeneous porous material is included in a vacuum-tight manner and also a constant wall thickness is thereby maintained.

By means of standardised dimensions of the heat-insulated receptacles which are used and taking into account these dimensions even in the case of containers for water and the vessels which can be used with the invention, improved handling ability, safety and a more optimum usage of space is possible.

Additional connections for energy or previously present tanks and lines in a vehicle for preparation of hot beverages which cause a very high maintenance cost are no longer required.

By means of a large number of dispensing elements containing also different concentrates, great flexibility for making available the most varied of beverages is provided without the mass which must be jointly transported for this purpose being significantly increased, which in turn reduces the transport costs and/or the possible usage burden.

Vessels, in particular those which are provided for receiving a portion, can be configured as compostable disposable articles.

The invention is intended to be explained by way of example in more detail subsequently.

There are thereby shown:

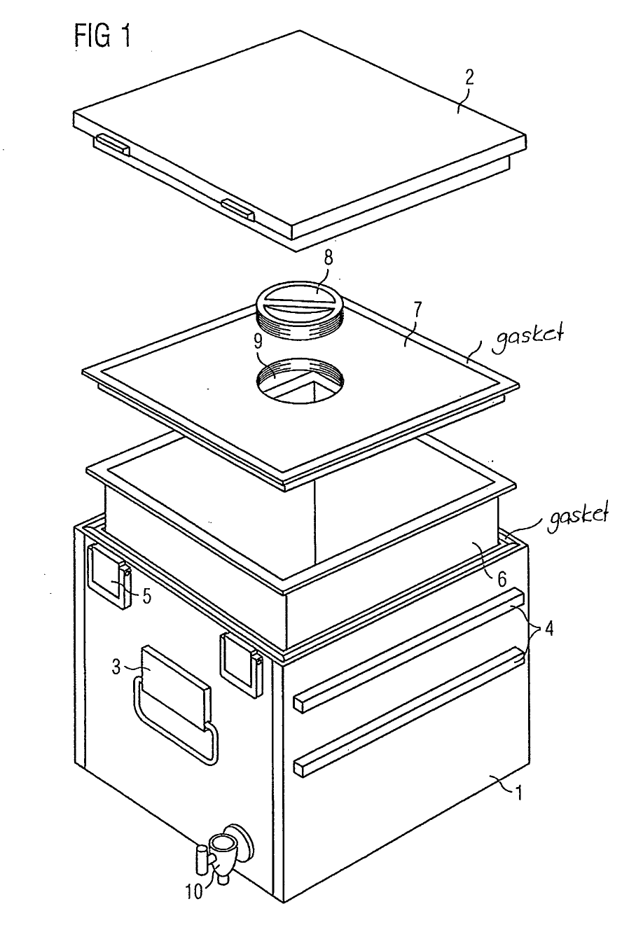

FIG. 1 elements usable with the invention;

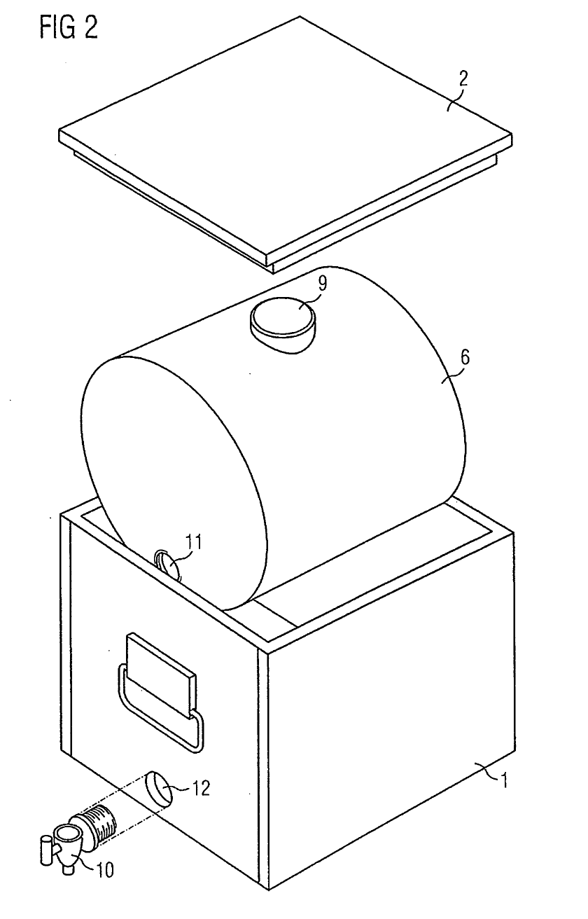

FIG. 2 a heat-insulating receptacle with container for water and

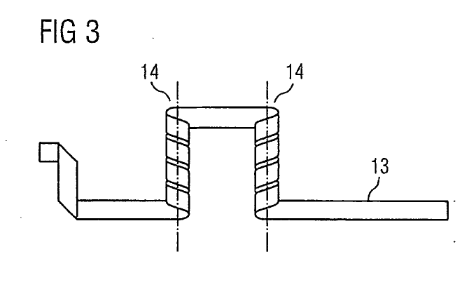

FIG. 3 an example of a cable guide usable with the invention.

In FIGS. 1 and 2, respectively one heat-insulating receptacle 1 is shown, which can be sealed with a cover element. Protected by an external protective cover made of a plastic material, vacuum insulation panels are present in the receptacle 1 and cover element 2.

The upper end-face of the receptacle 1 and the corresponding circumferential edge region of the cover element 2 has a configuration complementary thereto so that they form a labyrinth seal. Additional sealing elements, such as sealing lips, which are able to be introduced into recesses can thereby be present.

Handles 3 and webs 4 for improved handling are present externally. The cover element 2 can be connected by two hinge elements 5 to the heat-insulating receptacle 1 and the latter can consequently be sealed.

Into the heat-insulating receptacle 1, a container 6 which is likewise heat-insulating can be inserted here. Temperature-controlled liquid or water can be contained directly in the container 6. However, the possibility also exists, not represented in FIG. 1, of using at least one further flexible container which has been produced from a flexible foil. The illustrated container 6 can then be understood as insert element.

Like the receptacle 1, the container 6 can also be sealed with a cover element 7. The seal here should also be configured such as was described already for the receptacle 1. In this example, a filling opening 9 is present in the cover element 7 of the container 6, which opening can be sealed with a sealing element 8. Again seal elements are present on the filling opening 9 and sealing element 8. The sealing element 8 can be kept closed in the filling opening 9 alone or additionally with the help of the cover element 2 of the receptacle 1 if the cover element 2 seals the receptacle 1 and hence the sealing element 8 is pressed into the filling opening 9 so that the outer edge of the sealing element 8 is pressed against the inner edge of the filling opening 9.

Externally on the heat-insulating receptacle 1, a sealable outflow element 10 is fitted in this example, out of which temperature controlled liquid or water can be removed in portions. A connection in the form of a line to the interior of the container 6 is thereby present (not illustrated). In the sealing element 8, a pressure equalisation opening, a valve or a membrane can be present for pressure equalisation.

In FIG. 2, an example of a container 6 is shown, which has a cylindrical shape and can be inserted into a heat-insulating receptacle 1 which is configured analogously to the receptacle 1 according to FIG. 1. It can be detected here that an outflow opening 11 is present on the container 6 and is disposed there such that it communicates with a further outflow opening 12 on the receptacle 1. The outflow element 10 can be readily guided through the two outlet openings 11 and 12 and temperature-controlled liquid can be removed from the container 6. The container 6 in this example is closed on all sides apart from the outflow opening 11 and the filling opening 9.

Due to the cylindrical shape, cavities which are usable for other elements, such as energy stores, sensors, data transfer- and -storage, heating, cooling and temperature homogenisation, remain within the heat-insulating receptacle.

However, an insert element with a complementary contour can be inserted into the receptacle 1, however in a not represented shape, with which the container 6 can be fixed securely in the receptacle 1. An insert element can however also receive and fix the additional elements, mentioned here above.

A very advantageous example of a cable guide is shown in FIG. 3. Since it can be necessary with the invention to be able to transmit signals, data or even electric energy with wires, which can be required also in the interior of a receptacle 1 or in or to a container 6 or an insert element, suitable lines must be introduced from outside.

A leadthrough of a cable 13 or a line through the wall and in particular through a vacuum insulation panel reduces the insulation effect considerably and should be avoided as much as possible. In this way, also great complexity for a possibly required exchange of a defective line or cable 13 would be required since in fact the heat insulation must be taken into account and renewed again after an exchange.

Since however openings are present anyway on the receptacles 1 or even containers 6, these can be used to introduce cables 13 or lines into the interior.

On receptacles 1 or containers, used with the invention, as already mentioned cover elements 2 and 7 or otherwise configured elements which seal openings can be present, which must be connected to a receptacle 1 or container 6, this can be effected with the help of hinges.

Double hinge joints can preferably be used.

It can also be critical frequently to bend such flexible cables 13 or lines since the result consequently can be breakages in the lines. In order to counteract this, a line or a cable 13 can be wound in a spiral at least in one region. This region can be wound about the axis of rotation 14 at a hinge. During a movement, no bending or not too great bending of a line or of a cable 13 is thus effected in this otherwise critical region since, during the pivot movement of the cable 13 or of the line, the spirally wound region there absorbs the movement. The diameter of the spiral is increased and reduced according to the direction of movement. A cable 13 or a line can thus be mounted on the heat-insulating receptacle 1.

Advantageously, an interruption can be present on a hinge at a transition point for a cable 13 or a line.

At one end of a cable 13 or line, also a plug with connection contacts can be present, which plug can be introduced into a counterpart for transmitting signals, data or electric energy. Such a counterpart can be installed on a heat-insulating receptacle on the external wall. As a result, a possibly required exchange of a cable 13 or a line can be simplified.

1. System for providing portioned and temperature-controlled beverages in mobile use; in which a heat-insulated receptacle (1) for receiving at least one container (6) containing temperature-controlled water and at least one dispensing element containing a liquid or powder concentrate are present.

2. System according to claim 1, characterised in that the heat-insulated receptacle (1) has a heat-conduction coefficient of less than 0.05 W/mK.

3. System according to claim 1, characterised in that the heat-insulated receptacle (1) is formed with at least one vacuum insulation panel element.

4. System according to claim 1, characterised in that at least one contoured insert element for securely positioned receiving of objects, packaging, containers or vessels can be inserted in a heat-insulating receptacle (1).

5. System according to claim 1, characterised in that the interior of the heat-insulated receptacle (1) and container (6) containing water and/or vessels for serving are designed and dimensioned such that the interior can be filled completely with containers (6) and/or vessels.

6. System according to claim 1, characterised in that receptacles (1) and vessels (6) have a cornered cross-sectional geometry.

7. System according to claim 1, characterised in that the at least one container (6) containing water has an outflow element (10) for portioned output of temperature-controlled water into vessels.

8. System according to claim 1, characterised in that a container (6) containing water is formed with an outer cover and a liquid-impermeable foil.

9. System according to claim 1, characterised in that latent energy stores, heat tubes, two-phase thermosiphons for cooling or heating can be inserted into a heat-insulated receptacle (1) or cooling or heating elements are present.

10. System according to claim 8, characterised in that the energy supply for cooling or heating elements is effected by an electric energy storage element, a fuel cell or at least one photovoltaic element.

11. System according to claim 8, characterised in that a cooling and/or heating element is a Peltier element.

12. System according to claim 1, characterised in that identification elements are fitted on heat-insulating receptacles (1), containers (6) containing water, dispensing elements and/or vessels.

13. System according to claim 1, characterised in that an element optically displaying the internal temperature is present on a heat-insulating receptacle (1).

14. System according to claim 1, characterised in that a pressure container containing gas under pressure can be connected to containers (6) containing water.

15. System according to claim 1, characterised in that a door element or cover element (2) is present on a heat-insulating receptacle (1).

16. System according to claim 1, characterised in that an outflow element (10) for water to which a container (6) containing water can be connected is present on a heat-insulating receptacle (1).

17. System according to claim 1, characterised in that a container (6) is configured with a plurality of chambers.

18. System according to claim 1, characterised in that an indicator element is present on a heat-insulating receptacle (1), with which a contents identification for cooled or heated contents is made possible from outside.

19. System according to claim 1, characterised in that a cable (13) or a line is mounted on a hinge on the heat-insulating receptacle (1) and a spirally wound part is thereby wound about the axis of rotation of the hinge.
